(19) United States
(12) Patent Application Publication
(10) Pub. No.: US 2022/0230342 A1
(43) Pub. Date: Jul. 21, 2022

(54) INFORMATION PROCESSING APPARATUS THAT ESTIMATES OBJECT DEPTH, METHOD THEREFOR, AND STORAGE MEDIUM HOLDING PROGRAM THEREFOR

(71) Applicant: CANON KABUSHIKI KAISHA, Tokyo (JP)

(72) Inventors: Naoko Ogata, Tokyo (JP); Masashi Nakagawa, Tokyo (JP)

(21) Appl. No.: 17/576,759

(22) Filed: Jan. 14, 2022

(30) Foreign Application Priority Data
Jan. 20, 2021 (JP) 2021-007534

(51) Int. Cl. G06T 7/593; G06T 7/60; G06T 7/90; H04N 13/156; G06V 10/74; G06T 7/70; H04N 13/00

(52) U.S. Cl. CPC G06T 7/593; G06T 7/60; G06T 7/90; H04N 13/156; H04N 2013/0081; G06T 7/70; H04N 2013/0077; G06T 2207/10012; G06T 2207/10024; G06V 10/761

(57) ABSTRACT

An information processing apparatus includes an extraction unit configured to extract a region of an object from each of two images captured from two viewpoints, a processing unit configured to process each of the two images based on the region of the object, a detection unit configured to detect correspondence points from the regions of the object in the two images that have been processed by the processing unit, and an estimation unit configured to estimate a depth of the object from the two viewpoints based on locations of the two viewpoints and locations of the correspondence points in the two images.

### BACKGROUND

### Field of the Disclosure

The present disclosure relates to a technique for estimating arrangement of objects.

### Description of the Related Art

In recent years, research has been conducted on mixed reality. In mixed reality, information about a virtual space is superimposed on a real space in real time and the resultant image is presented to a user. A rendering processing apparatus used in mixed reality entirely or partially superimposes real images captured by imaging apparatuses such as video cameras on computer graphic (CG) images in a virtual space generated based on the locations and orientations of the imaging apparatuses and displays the resultant synthesis images.

In this operation, by detecting a region of a certain object from images in the real space and estimating a three-dimensional (3D) shape of the object, the real object can be synthesized in the virtual space. As a method for estimating the 3D shape, there is a stereo measurement method that uses a plurality of cameras. In the stereo measurement, camera parameters such as focal lengths of the respective cameras or the relative locations and orientations between the cameras are estimated in advance by calibration of the imaging apparatuses, and a depth can be estimated by the principle of a triangulation method from correspondence points in captured images and the camera parameters.

Such an estimated depth value needs to be updated in real time as frequently as a frame rate. That is, both of estimation accuracy and an estimation speed need to be ensured.

Japanese Patent Application Laid-Open No. 2017-45283 discusses a technique for addressing this issue. According to this technique, first, block matching is performed on all stereo images, and respective correspondence points between stereo images are detected. Next, based on the disparity, a depth is estimated, and a distance from an object, for which the depth is to be measured, to the each camera is determined as an estimated distance range. The depth is measured again by setting a search range of the block matching to the estimated distance range. This is based on, for example, a notion that, since a distance range in which a hand exists can be estimated if the location of a face is determined, the range can be narrowed. By performing the block matching within a range narrowed as described above, the correspondence points can be detected accurately, and as a result, the depth estimation can be performed accurately.

Since each stereo image is captured at a different location, there are cases where a structure rendered in one image is not rendered in another image. For example, FIGS. 1A and 1B illustrate examples of right and left images captured by stereo cameras. FIG. 1A illustrates an image captured by a left camera, and FIG. 1B illustrates an image captured by a right camera. While a cube 101 is captured behind a hand as an object in FIG. 1A, the cube 101 is not captured in FIG. 1B. Since the imaging location of each camera differs, there are cases where each stereo image includes a different structure. In such cases, mismatching could occur in stereo matching, and an erroneous correspondence point could be detected between stereo images. This is also the case with the technique discussed in Japanese Patent Application Laid-Open 2017-45283, and information other than information about an object whose depth is to be estimated could adversely affect the stereo matching, and the accuracy of the depth estimation could be deteriorated.

### SUMMARY

According to an aspect of the present disclosure, an information processing apparatus includes an extraction unit configured to extract a region of an object from each of two images captured from two viewpoints, a processing unit configured to process each of the two images based on the region of the object, a detection unit configured to detect correspondence points from the regions of the object in the two images that have been processed by the processing unit, and an estimation unit configured to estimate a depth of the object from the two viewpoints based on locations of the two viewpoints and locations of the correspondence points in the two images.

Further features of the present disclosure will become apparent from the following description of exemplary embodiments with reference to the attached drawings.

### BRIEF DESCRIPTION OF THE DRAWINGS

FIGS. 1A and 1B illustrate examples of stereo images acquired by cameras.

FIG. 2 is a block diagram illustrating a functional configuration example of a system.

FIG. 3 is a block diagram illustrating a hardware configuration example of an information processing apparatus.

FIG. 4 is a flowchart illustrating an example of processing performed by the information processing apparatus.

FIGS. 5A and 5B illustrate examples of images whose background region has been filled with a single color.

FIGS. 6A, 6B and 6C illustrate examples of images indicating an issue caused when the background region is filled with a single color.

FIG. 7 illustrates an example of a filter for adding structure information about an object to the background region.

FIGS. 8A, 8B and 8C illustrate examples of images obtained after the structure information about the object has been added to the background region.

FIGS. 9A and 9B illustrate examples of images obtained after inter-image correspondence information has been added to the background region.

### DESCRIPTION OF THE EMBODIMENTS

Hereinafter, exemplary embodiments of the present disclosure will be described in detail with reference to drawings. The configurations described in the following exemplary embodiments are representative examples, and the scope of the present disclosure is not necessarily limited to these specific configurations.

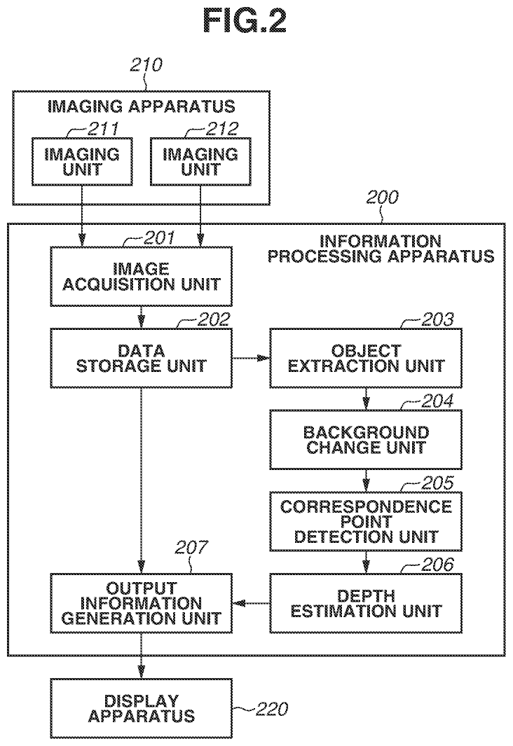

FIG. 2 is a block diagram illustrating a functional configuration example of a system according to a first exemplary embodiment. As illustrated in FIG. 2, in the system according to the present exemplary embodiment, an information processing apparatus 200 is connected to an imaging apparatus 210 and a display apparatus 220.

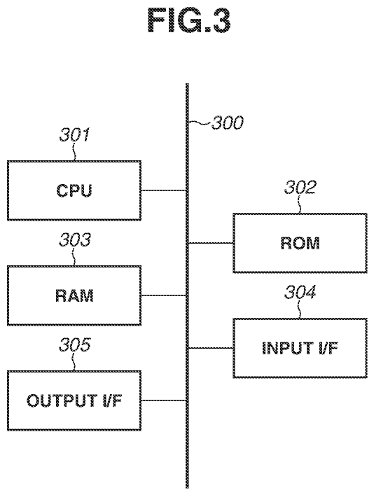

The information processing apparatus 200 will be described. FIG. 3 illustrates a hardware configuration of the information processing apparatus 200 according to the present exemplary embodiment. In FIG. 3, a central processing unit (CPU) 301 comprehensively controls each device connected thereto via a bus 300. The CPU 301 reads and executes commands or programs stored in a read-only memory (ROM) 302. An operating system (OS), various processing programs according to the present exemplary embodiment, device drivers, etc. are stored in the ROM 302, are temporarily stored in a random access memory (RAM) 303, and are executed by the CPU 301 as needed.

An input interface (I/F) 304 receives, from the external apparatus (imaging apparatus) 210, input signals in a format processable by the information processing apparatus 200. An output I/F 305 outputs output signals in a processable format to the external apparatus (display apparatus) 220.

Referring back to FIG. 2, the imaging apparatus 210 includes an imaging unit 211 and an imaging unit 212 to input images acquired from these imaging units 211 and 212 to the information processing apparatus 200. In the present exemplary embodiment, an image acquired by the imaging unit 211 will be referred to as a left-eye image (image from a left viewpoint), and an image acquired by the imaging unit 212 will be referred to as a right-eye image (image from a right viewpoint).

An image acquisition unit 201 acquires the images captured by the imaging units 211 and 212 of the imaging apparatus 210 as stereo images and stores the acquired stereo images in a data storage unit 202.

The data storage unit 202 holds the stereo images received from the image acquisition unit 201, data of a virtual object, and color and shape recognition information used for object extraction.

An object extraction unit 203 extracts a region of a certain object region from the stereo images. For example, color information about an object is registered in advance, and a region matching the registered color information is extracted from each of the stereo images.

A background change unit 204 sets a region other than the object region extracted by the object extraction unit 203 as a background region and changes the background region by processing the background region in the each stereo image, e.g., by filling the background region with a color. In this way, the background change unit 204 generates stereo images whose background has been changed. These stereo images will be referred to as background-changed stereo images, as needed.

A correspondence point detection unit 205 performs stereo matching for associating equivalent points between stereo images using the background-changed stereo images generated by the background change unit 204.

A depth estimation unit 206 estimates a depth based on a triangulation method from a pair of correspondence points detected by the correspondence point detection unit 205.

An output information generation unit 207 further performs, based on the depth estimated by the depth estimation unit 206, processing based on the intended use, as needed. For example, the output information generation unit 207 further performs rendering processing on the captured stereo images. For example, based on the depth, a polygonal model of the object can be generated, and a synthesis image can be generated by performing an occlusion expression between the object and a virtual object from the data of the virtual object stored in the data storage unit 202 and by synthesizing the captured images and the virtual object. Alternatively, whether the object is in contact with a virtual object can be determined based on a 3D location acquired from the depth, and the determination result can be displayed. The processing performed herein is not particularly limited. Suitable processing can be performed, for example, based on an instruction from a user or a program that is executed. The output image data obtained as a result of the processing is output to and displayed on the display apparatus 220.

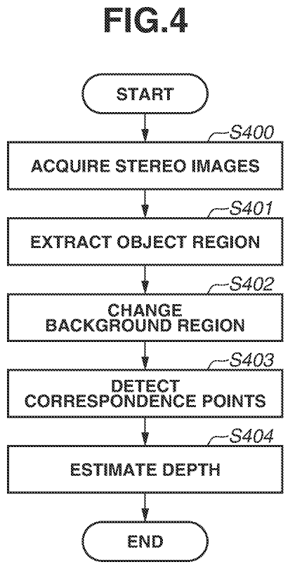

FIG. 4 is an example of a flowchart illustrating processing performed by the information processing apparatus 200. The processing includes a flow from changing the background regions of the stereo images to estimating the depth. Hereinafter, each step will be described with reference characters including S as its initial character.

In step S400, the image acquisition unit 201 acquires stereo images captured by the imaging units 211 and 212. The image acquisition unit 201 is, for example, a video capture card that acquires images from the imaging units 211 and 212. The acquired stereo images are stored in the data storage unit 202.

In step S401, the object extraction unit 203 extracts a region of an object from each of the stereo images stored in the data storage unit 202. For example, a feature of an object can be previously learned through machine learning. In this case, the object extraction unit 203 determines a region having the learned feature as the region of the object and extracts such region. Alternatively, an object can be extracted by previously registering the color of the object. Herein, a region of an object in an image will be defined as an object region, whereas a region other than the object region will be defined as a background region.

In step S402, the background change unit 204 fills the region determined as the background region by the object extraction unit 203 with a single color, to generate background-changed stereo images.

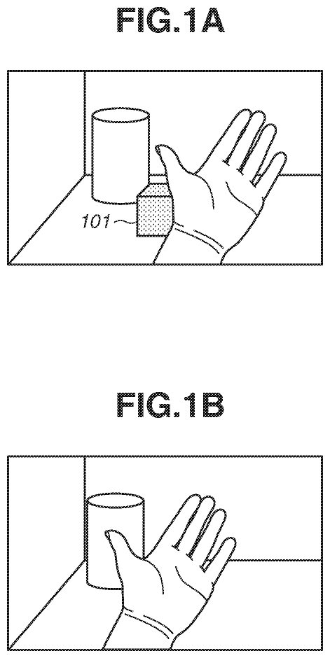

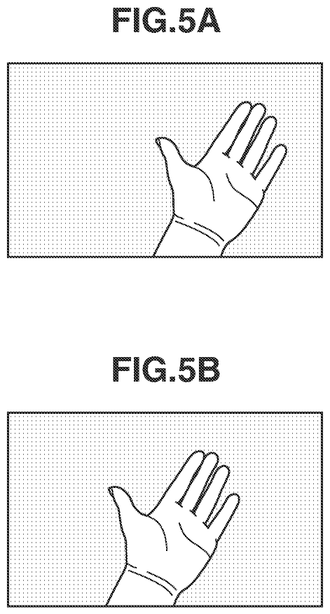

FIGS. 5A and 5B each illustrate an image example in which a hand is used as an object and the background has been changed by the background change unit 204. FIG. 5A illustrates a result obtained by changing the background in FIG. 1A, which is an image captured by a left camera, and FIG. 5B illustrates a result obtained by changing the background in FIG. 1B, which is an image captured by a right camera. By generating such background-changed stereo images having changed background regions, it is possible to eliminate a structural difference in the background regions between images, which is illustrated as an issue in FIGS. 1A and 1B.

In step S403, the correspondence point detection unit 205 adopts stereo matching processing for detecting correspondence points from a pair of background-changed stereo images, which are the processed images. For this stereo matching processing, for example, semi-global matching (SGM) can be adopted (cf. H. Hirschmuller, “Stereo processing by semiglobal matching and mutual information”, IEEE Transactions on Pattern Analysis and Machine Intelligence (PAMI), 30(2):328-341, February 2008.). The present exemplary embodiment is not limited to use of SGM for stereo matching. Epipolar lines (scanning lines) for associating a sampling point in a left-eye image with a sampling point in a right-eye image can be rendered. In this case, correlation can be calculated based on a local region on the epipolar lines, and a point having the highest correlation can be detected as a correspondence point. Alternatively, a matching cost between images can be represented as energy, and the energy can be optimized by a graph cut method.

In step S404, the depth estimation unit 206 determines a depth value of a correspondence point using the triangulation method. That is, the depth estimation unit 206 determines the depth value of the correspondence point based on correspondence information about a correspondence point detected by the correspondence point detection unit 205, the relative locations and orientations of the imaging units 211 and 212 of the imaging apparatus 210, and camera internal parameters (lens distortion, perspective projection transformation information). The correspondence point information, in which the information about the depth value of the correspondence point and a 3D location of the imaging apparatus are associated with each other, is stored in the RAM 303.

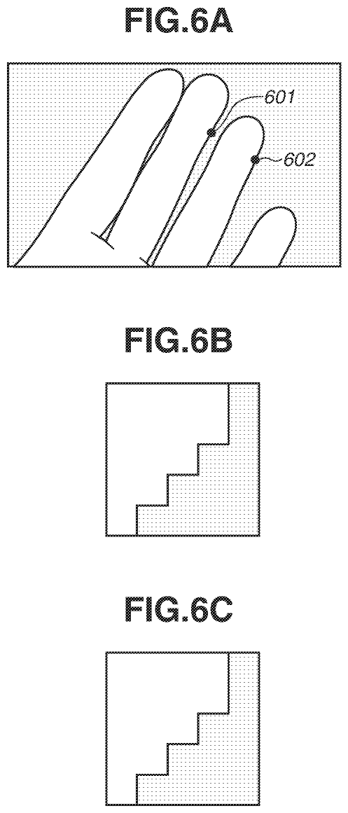

In the above first exemplary embodiment, a case where the background region is filled with a single color is described. In this case, for example, FIG. 6B illustrates an expanded search block range having, as its center, a point of interest 601 of stereo matching in FIG. 6A, which is a background-changed stereo image, and FIG. 6C illustrates an expanded search block range having, as its center, a point of interest 602 of the same. In a case where the background is filled with a single color, surroundings of the points 601 and 602 look similar to each other, and mismatching may occur in the stereo matching.

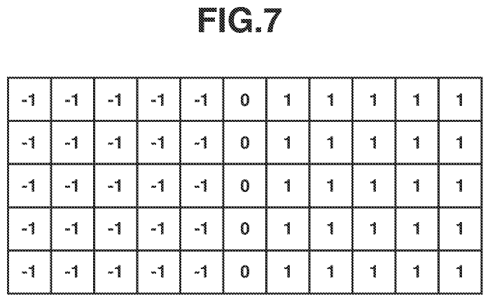

Thus, in a second exemplary embodiment, in view of this case, structure information about the object can be added to the background. That is, the object extraction unit 203 can create an image in which the extracted object region and the background region are binarized. In addition, the background change unit 204 can perform, for example, a convolution operation with a filter illustrated in FIG. 7, determine whether there is an object region in the vicinity, and change the background. This filter is a little larger than an SGM block used for the detection by the correspondence point detection unit 205. In a case where the object is on the left of a point of interest, a negative value is output, whereas in a case where the object is on the right of a point of interest, a positive value is output.

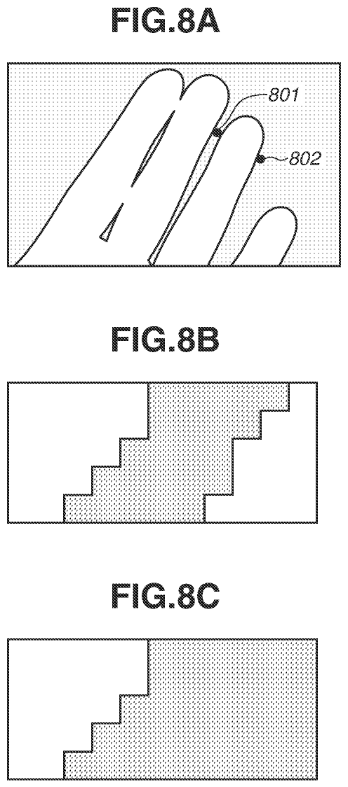

FIG. 8A illustrates an image in which the image in FIG. 6A has been binarized. FIG. 8B illustrates an expanded filter range having, as its center, a point of interest 801 at a location equivalent to that of the background region in FIG. 6B. FIG. 8C illustrates an expanded filter range having, as its center, a point of interest 802 at a location equivalent to that of the background region in FIG. 6C. When a region in the vicinity of the point of interest is seen more globally than the search block in FIG. 6B or 6C, it is seen that FIG. 8C does not include an object on the right side while FIG. 8B includes an object on the right side. In this case, if the convolution operation is performed on a binarized image using the filter in FIG. 7, the background region in FIG. 8B represents a value close to 0, and the background region in FIG. 8C represents a negative value. While the blocks in FIGS. 6B and 6C cannot be distinguished from each other, since FIGS. 8B and 8C are differentiated in the background region, the correspondence point detection unit 205 is able to distinguish FIGS. 8B and 8C from each other.

As described above, the correspondence point detection unit 205 may detect an erroneous correspondence point when the background region is filled with a single color and when there are object regions that are very similar to each other. However, by adding the structure information about the object to the background region, the correspondence point detection unit 205 can detect a correct correspondence point.

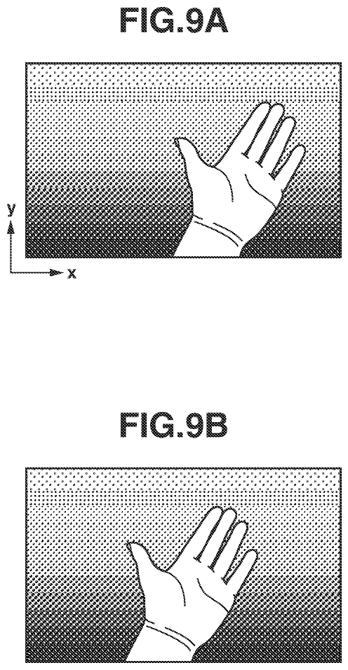

In the above first exemplary embodiment, a case where the background region is filled with a single color has been described as an example. In the above second exemplary embodiment, a case where the structure information about an object is added to the background region has been described as an example. In contrast, in a third exemplary embodiment, inter-image correspondence information (information about epipolar lines) is added to the background region. For example, rectification is performed based on the relative locations and orientations of the imaging units 211 and 212 with respect to the stereo images acquired by the image acquisition unit 201 and the camera internal parameters. In view of the fact that the epipolar lines are horizontal in the stereo images on which the rectification has been performed, information about the epipolar lines is added to the background. That is, as FIG. 9A illustrating a left-eye image and FIG. 9B illustrating a right-eye image, assuming that image coordinates are represented by (x, y), the background change unit 204 sets a background color based on the y coordinate in the background region, that is, based on the location in a vertical direction.

As described above, the correspondence point detection unit 205 may detect an erroneous correspondence point when the background region is filled with a single color and when there are object regions very similar to each other. However, by adding the inter-image correspondence information to the background region, the correspondence point detection unit 205 can detect a correct correspondence point.

According to the above exemplary embodiments, the depth of an object can be estimated accurately and quickly.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2021-007534, filed Jan. 20, 2021, which is hereby incorporated by reference herein in its entirety.

What is claimed is:

1. An information processing apparatus comprising:
an extraction unit configured to extract a region of an object from each of two images captured from two viewpoints;
a processing unit configured to process each of the two images based on the region of the object;
a detection unit configured to detect correspondence points from the regions of the object in the two images that have been processed by the processing unit; and
an estimation unit configured to estimate a depth of the object from the two viewpoints based on locations of the two viewpoints and locations of the correspondence points in the two images.

2. The information processing apparatus according to claim 1, wherein the processing unit changes a color of a region other than the region of the object.

3. The information processing apparatus according to claim 2, wherein the processing unit fills a region other than the region of the object with a single color.

4. The information processing apparatus according to claim 1, wherein the processing unit adds structure information about the object to the two images.

5. The information processing apparatus according to claim 4, wherein the processing unit adds, to the two images, a state of the object in an area in a vicinity of a point of interest in each of the two images, as the structure information about the object.

6. The information processing apparatus according to claim 5, wherein the processing unit adds, to the two images, a state of the object in an area in the vicinity of the point of interest in each of the two images and a state in an area near the point of interest, the area being a more global area than the area in the vicinity of the point of interest, as the structure information about the object.

7. The information processing apparatus according to claim 1, wherein the processing unit adds, to the two images, correspondence information between the two images.

8. The information processing apparatus according to claim 7, wherein the processing unit adds, to the two images, information about an epipolar line as the correspondence information between the two images.

9. The information processing apparatus according to claim 8, wherein the processing unit rectifies the two images in such a manner that the epipolar line becomes horizontal and sets a color of a region other than the region of the object based on a location in a vertical direction.

10. The information processing apparatus according to claim 1, wherein the extraction unit extracts a region of the object from each of the two images based on color information.

11. The information processing apparatus according to claim 1, further comprising a generation unit configured to generate an output image based on the depth estimated by the estimation unit.

12. The information processing apparatus according to claim 11, wherein the generation unit generates an image in which a virtual object is synthesized with each of the captured two images based on the estimated depth.

13. The information processing apparatus according to claim 1, further comprising a determination unit configured to determine whether the object is in contact with a virtual object based on the depth estimated by the estimation unit.

14. An information processing method comprising:
extracting a region of an object from each of two images captured from two viewpoints;
processing each of the two images based on the region of the object;
detecting correspondence points from the regions of the object in the two images that have been processed; and
estimating a depth of the object from the two viewpoints based on locations of the two viewpoints and locations of the correspondence points in the two images.

15. A non-transitory computer-readable storage medium holding a program that causes a computer to execute an information processing method, the method comprising:
extracting a region of an object from each of two images captured from two viewpoints;
processing each of the two images based on the region of the object;
detecting correspondence points from the regions of the object in the two images that have been processed; and
estimating a depth of the object from the two viewpoints based on locations of the two viewpoints and locations of the correspondence points in the two images.
